(19) United States
(12) Patent Application Publication
(10) Pub. No.: US 2010/0198833 A1
(43) Pub. Date: Aug. 5, 2010

(54) SYSTEM AND METHOD FOR SOCIAL NETWORKING

(76) Inventor: MICHAEL THOMAS DEPAOLI, SCOTTSDALE, AZ (US)

Correspondence Address: ROBERT A. PARSONS, 4000 N. CENTRAL AVENUE, SUITE 1220, PHOENIX, AZ, 85012, US

(21) Appl. No.: 12/694,894

(22) Filed: Jan. 27, 2010

Related U.S. Application Data
(60) Provisional application No. 61/147,857, filed on Jan. 28, 2009.

(51) Int. Cl. G06F 15/16; G06F 17/30; G06F 3/01

(52) U.S. Cl. 707/741; 709/204; 715/760; 707/E17.014

(57) ABSTRACT

A method of social networking including the step of providing a networking system with a website on a web network. The method further includes the steps of receiving from a claimant entering the website an agreement to the terms of service and thereafter receiving the claimant as a member, receiving from the claimant the name of a person claimed and other relevant information, and indexing and storing the claims so as to permit searching by the public and/or members of the networking system. In addition the networking system is constructed to receive facts arising from a dispute proving the claim is invalid or erroneous, and notify the claimant of the dispute in some convenient manner.

### CROSS-REFERENCE TO RELATED APPLICATIONS

This application claims the benefit of U.S. Provisional Application No. 61/147,859, filed 28 Jan. 2009

### FIELD OF THE INVENTION

This invention relates to social networking.

More particularly, the present invention relates to social networking on the World Wide Web.

### BACKGROUND OF THE INVENTION

In many instances an individual may have a monogamous relationship, such as marriage, steady girl friend/boy friend, engagement and the like, and others in a social network may not be informed and may pursue one or the other of the relationship. Such misunderstandings with individuals can produce substantial emotional injury and a resulting enmity. There are essentially two potential groups of victims. There are those individuals who are being cheated on, and there are those individuals who believe they have found someone with whom a monogamous relationship can develop only to later learn the person is already in a relationship.

It would be highly advantageous, therefore, to remedy the foregoing and other deficiencies inherent in the prior art.

An object of the present invention is to provide a new and improved system and method of social networking.

Another object of the present invention is to provide a new and improved system of social networking to notify the world of a commitment between two individuals.

### SUMMARY OF THE INVENTION

Briefly, to achieve the desired objects of the present invention in accordance with a preferred embodiment provided is a method of social networking including the step of providing a networking system with a website on a web network. The method further includes the steps of receiving from a claimant entering the website an agreement to the terms of service and thereafter receiving the claimant as a member, receiving from the claimant the name of a person claimed and other relevant information, and indexing and storing the claims so as to permit searching by the public and/or members of the networking system. In addition the networking system is constructed to receive facts arising from a dispute proving the claim is invalid or erroneous, and notify the claimant of the dispute in some convenient manner.

To further achieve the desired objects of the present invention in accordance with a preferred embodiment provided is a social networking system including a website on a web network and including interactive structure and storage. The interactive structure is formed to provide to a claimant entering the website the terms of service and membership on an interactive screen structure to display the terms on a computer coupled through the website. The screen is also formed to receive an agreement to the terms, the name of a person claimed by the claimant, and other relevant information including at least age of the claimed person and location of the claimed person. The storage is connected to the interactive structure to receive claimant's membership, the name of the person claimed by claimant, and other relevant information including at least the age of the claimed person and the location of the claimed person. The storage is formed to index and store by at least one of name, age, location, and/or combinations thereof, so as to permit searching by the public and/or members of the networking system.

### BRIEF DESCRIPTION OF THE DRAWINGS

Specific objects and advantages of the instant invention will become readily apparent to those skilled in the art from the following detailed description of a preferred embodiment thereof taken in conjunction with the drawings, in which:

FIG. 1 is a simplified block diagram of a social networking system in accordance with the present invention;

FIGS. 2, 3, and 4 illustrate various interactive web screens provided to a remote computer by the structure of FIG. 1; and

FIG. 5 is a simplified flow diagram illustrating the social networking method in accordance with the present invention.

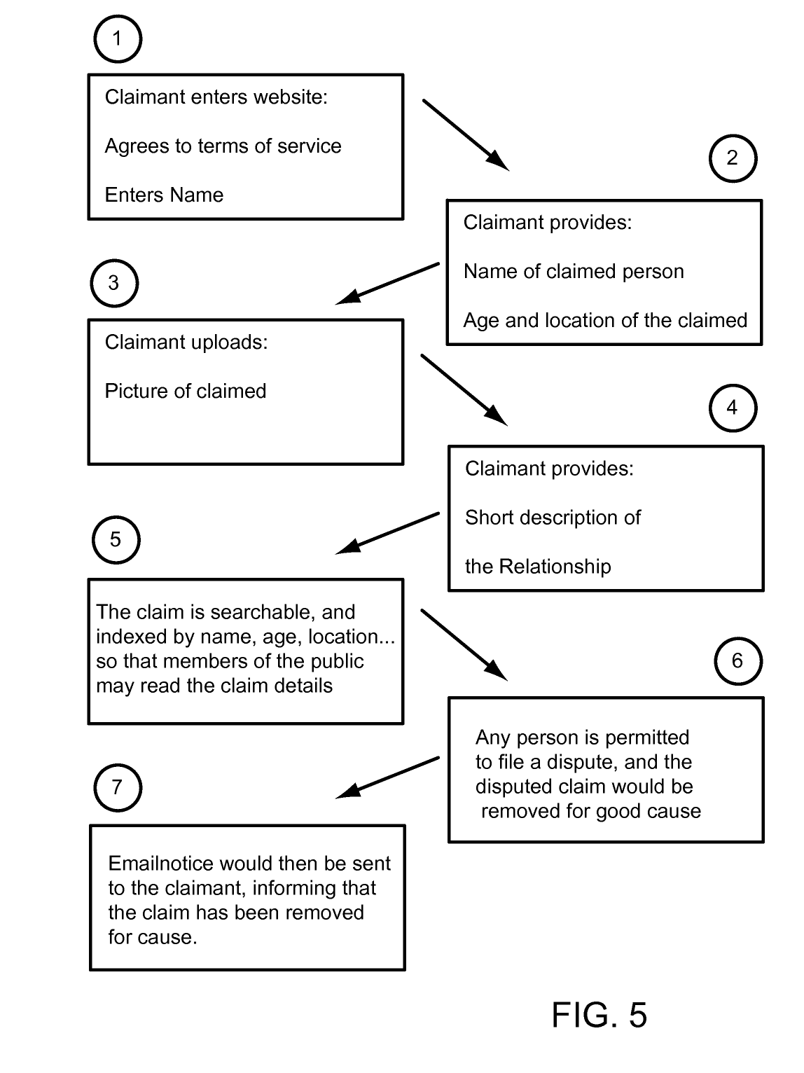

### DETAILED DESCRIPTION OF THE PREFERRED EMBODIMENT

The present system and method is preferably for use in association with social networking. The method is to notify individuals in a social network of a claimant's relationship with a person claimed. This method can provide confirmation of a relationship to the two parties involved and serve to notify the world of this commitment. The relationship claimed can be any having a significant other, such as marriage, steady girl friend/boy friend, engagement and the like. The intent is to confirm commitment to a relationship, and provide information to those individuals seeking a monogamous relationship. If an individual has been claimed, others in a social network can find this information and be informed instead of ignorant of the status of the individual pursued. By posting a “claim”, errors of misunderstanding with individuals can be avoided thereby preventing emotional injury. There are essentially two potential groups of victims. There are those individuals who are being cheated on, and there are those individuals who believe they have found someone with whom a monogamous relationship can develop only to later learn the person is already in a relationship.

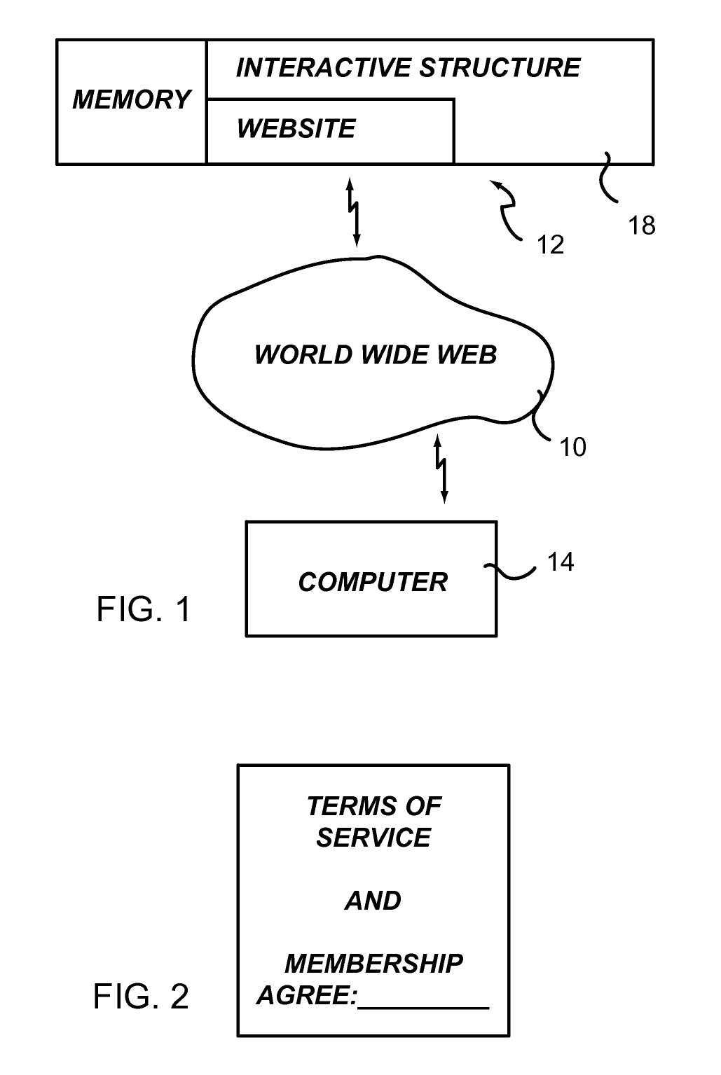

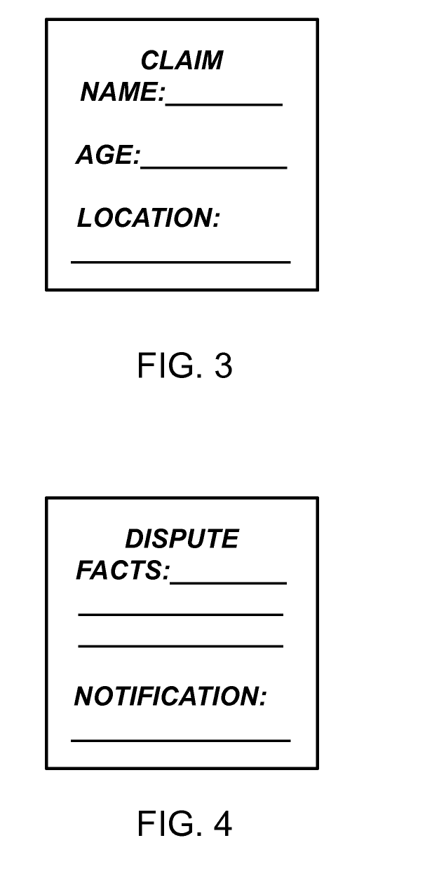

The system, referring to FIG. 1, includes a website 12 and access to the World Wide Web 10 or other network, through an input device 14, such as a computer, web capable phone, PDA and the like. Through World Wide Web 10 input device 14 has access to website 12 which includes an indexing memory 16 and the necessary interactive structure 18 that provides at least one interactive screen. As an example of one embodiment, a first interactive screen illustrated in FIG. 2 includes terms of service and membership to which a person may agree and become a member. Any member who has a claim on a person may then access interactive screen 2, illustrated in FIG. 3. Using screen 2, data is input for a specific claimant and individual claimed. This data includes the name of the claimant, the name of the claimed individual, the age of the claimed individual, the geographic location/residence of the claimed individual, a picture of the claimed individual, and any other information desired or that will aid in identifying the individual. A short description of the relationship could also be supplied. This method is completely voluntary.

Also, to prevent misuse or prevent disputed claiming, access to the system/method through interactive screen 3, illustrated in FIG. 4, permits a claimed individual or other, to file a dispute and have a claim removed for cause. Notice will be sent to the claimant of the removal of the claim.

It will be understood that screens 1-3 might be incorporated into a single screen or might be broadened into several additional screens if desired. Also, the formation and operation of the interactive structure including the interactive screens are well in the art and will not be discussed further in this disclosure except to explain that the interactive screens are transmitted to computer 14 and information input from computer 14 is automatically indexed and stored in memory 16 for later access.

Turning now to FIG. 4, one embodiment of a process in accordance with the invention is illustrated. The first step (1) in the process is for a claimant to enter the website of the present system and agree to the terms of service and become a member. In a second step (2) of the process, the claimant is asked to provide the name of the person claimed and other relevant information such as age, location and the like. A picture of the claimed individual is requested. In a third step (3) the claimant uploads a picture of the claimed individual. As a fourth and optional step (4) information can be entered, such as a short description of the relationship between claimant and claimed. Various formats for requesting the information can be used. A simple fill-in-the-blanks questionnaire can be employed, individual questions can be displayed or any of many well known methods of acquiring information can be utilized. In a fifth step (5) claims are indexed and stored by name, age, location, or combinations thereof so as to permit searching by the public and/or members of the site to see the claim details.

If a claimed individual or other person disputes the claim, a review process is entered as a sixth step (6). If facts arising from the dispute prove the claim is invalid, erroneous, etc., the claim is removed for good cause. When a claim is removed, the claimant is notified (seventh step (7)) in some convenient manner, such as by e-mail, that the claim on the individual has been removed. It will of course be understood that some of the above steps might be combined and/or additional steps might be added. For example at least one of the steps might require some proof of the relationship to reduce the possibility of harmful fraud or mischief.

Various changes and modifications to the embodiments herein chosen for purposes of illustration will readily occur to those skilled in the art. To the extent that such modifications and variations do not depart from the spirit of the invention, they are intended to be included within the scope thereof, which is assessed only by a fair interpretation of the following claims.

Having fully described the invention in such clear and concise terms as to enable those skilled in the art to understand and practice the same, the invention claimed is:

1. A method of social networking comprising the steps of:
providing a networking system with a website on a web network;
receiving from a claimant entering the website of the networking system an agreement to the terms of service and thereafter receiving the claimant as a member;
receiving from the claimant the name of a person claimed and other relevant information; and
indexing and storing the claims so as to permit searching by the public and/or members of the networking system.

2. A method as claimed in claim 1 wherein the relevant information includes age and location.

3. A method as claimed in claim 2 wherein the claims are indexed and stored by at least one of name, age, location, and combinations thereof.

4. A method as claimed in claim 1 including in addition a step of providing information including a short description of the relationship between claimant and the person claimed.

5. A method as claimed in claim 1 including in addition a step of the networking system receiving facts arising from a dispute proving the claim is invalid or erroneous, and a step of the networking system notifying the claimant of the dispute in some convenient manner.

6. A method of social networking comprising the steps of:
providing a networking system with a website on a web network, the website including interactive structure with at least one interactive screen and a memory;
transmitting to a remote computer through the web network terms of service and membership to an inquiring person, the transmission including an interactive screen displaying the terms;
receiving from the inquiring person via the interactive screen an agreement to the terms of service and thereafter receiving the claimant as a member;
receiving from a claimant/member a claim of a relationship with a person and transmitting to the claimant/member an interactive screen displaying requests for information;
receiving from the claimant through the interactive screen displaying requests for information the name of a person claimed and other relevant information; and
indexing and storing the claims in the memory so as to permit searching by the public and/or members of the networking system.

7. A method as claimed in claim 6 including in addition a step of transmitting a screen containing dispute information including requests for facts arising from a dispute proving a claim is invalid or erroneous and notifying the associated claimant in the dispute in some convenient manner.

8. A social networking system comprising:
a website on a web network and including interactive structure and storage;
the interactive structure formed to provide to a claimant entering the website the terms of service and membership, the interactive structure further including a screen formed to display the terms on a computer coupled through the website, the screen formed to receive an agreement to the terms, the name of a person claimed by the claimant, and other relevant information including at least age of the claimed person and location of the claimed person;
the storage being connected to the interactive structure to receive claimant's membership, the name of the person claimed by claimant, and other relevant information including at least age of the claimed person and location of the claimed person; and
the storage being formed to index and store by at least one of name, age, location, and combinations thereof, so as to permit searching by the public and/or members of the networking system.

9. A social networking system as claimed in claim 8 wherein the interactive structure includes a screen constructed to receive facts arising from a dispute proving the claim is invalid or erroneous, and to notify the claimant of the dispute in some convenient manner.
